(19) United States
(12) Patent Application Publication
(10) Pub. No.: US 2026/0054315 A1
(43) Pub. Date: Feb. 26, 2026

(54) SHOCK ABSORBER MOUNTED ON A DRILL BIT

(71) Applicant: Joseph Erik Gliksman, Rolling Hills Estates, CA (US)

(72) Inventor: Joseph Erik Gliksman, Rolling Hills Estates, CA (US)

(21) Appl. No.: 18/810,264

(22) Filed: Aug. 20, 2024

(51) Int. Cl. B23B 27/00

(52) U.S. Cl. CPC B23B 27/002

(57) ABSTRACT

A shock-absorbing article may be mounted on a drill bit by sliding the drill bit through one or more holes in the article. The article may have a mass of shock-absorbing material with a void extending through the mass. The void may be substantially the same diameter as, or a greater diameter than, the drill bit. The mass may be substantially a circular cylinder and have a center-of-mass that is within the void of the disk. The mass may comprise indicia that indicates the size of a compatible drill bit. The shock-absorbing material may be an elastomer. The article may further comprise a washer having a washer hole, and the washer hole may be substantially a circular cylinder.

### FIELD OF TECHNOLOGY

The embodiments discussed herein relate to drilling equipment.

### BACKGROUND

Drilling equipment is used to drill a cavity into a medium. When drilling into a medium the drill chuck may strike the medium. Thus, there is a need for drilling equipment that helps protect the medium from drill-chuck strikes.

### SUMMARY

A shock-absorbing article is disclosed. The article may be mounted on a drill bit and may have a mass of shock-absorbing material with a void extending through the mass. The mass may have a center-or-mass that is within the void, and the void may be substantially a circular cylinder. The diameter of the void may be substantially the same diameter as, or a greater diameter than, the drill bit. The mounting may comprise sliding the drill bit through the void. The mass may be disk-shaped having the void centrally located on the circular face of the disk. The mass may comprise indicia that indicates the size of a compatible drill bit. The shock-absorbing material may be an elastomer. The article may further comprise a washer having a washer hole. The washer may have a center-of-mass that is within the washer hole and the hole may be substantially a circular cylinder. The washer hole may be substantially the same diameter as, or a greater diameter than, the drill bit. The mounting on the drill bit may also comprise inserting the drill bit through the hole in the washer.

A drilling system is also disclosed. The system may comprise the drill bit, the mass of shock-absorbing material, and the washer. The drill bit may extend through the void in the mass and the hole in the washer.

A method of drilling a cavity into a medium is also disclosed. The method may comprise: mounting a shock-absorbing article on a drill bit, the article comprising a mass of shock-absorbing material having a void extending through the mass. The mass may have a center-of-mass that is within the void, and the void may be substantially a circular cylinder. The diameter of the void may be substantially the same diameter as, or a greater diameter than, the drill bit. The method may further comprise placing a cutting end of the drill bit on the medium and rotating the drill bit. The mass may be disk-shaped with the void centrally located on the circular face of the disk. The mass may comprise indicia that indicates the size of a compatible drill bit. The shock-absorbing material may be an elastomer. The article may further comprise a washer having a hole. The washer may have a center-of-mass that is within the hole, and the hole may be substantially a circular cylinder. The diameter of the washer hole may be substantially the same diameter as, or a greater diameter than, the diameter of the drill bit. The mounting may comprise inserting the drill bit through the hole in the mass and the hole in the washer.

Also disclosed is a process of making a shock-absorbing article that may be mounted on a drill bit. The process may comprise fashioning a mass of shock-absorbing material, the mass having a void extending through the mass. The void may be centrally located in the mass, the mass may have a center-of-mass that is within the void, and the void may be substantially a circular cylinder. The diameter of the void may be substantially the same diameter as, or a greater diameter than, the drill bit. The fashioning may comprise: molding, stamping, extruding, casting, printing, forming, painting, machining, and cutting. The mass may comprise indicia that indicates the size of the drill bit. The mass may be an elastomer. The process may further comprise selecting a washer having a washer hole. The washer hole may be centrally located in the washer, and may be substantially a circular cylinder. The washer hole may be substantially the same diameter as, or a greater diameter than, the drill bit. The mounting may comprise inserting the drill bit through the void in the mass and the hole in the washer.

### BRIEF DESCRIPTION OF THE DRAWINGS

Example embodiments are illustrated by way of example and not limitation in the figures of accompanying drawings, in which like references indicate similar elements and in which:

FIG. 1 is a drawing of one embodiment of a mass of shock-absorbing material having a hole.

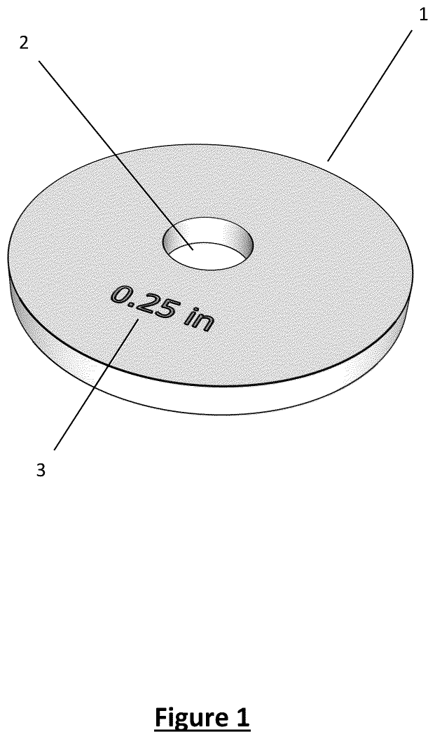

FIG. 2 is a drawing of one embodiment of a washer having a hole.

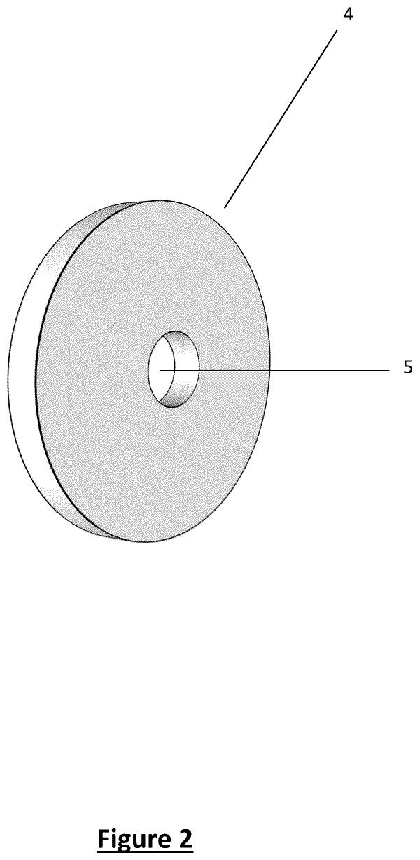

FIG. 3 is a drawing of one embodiment of a drill bit.

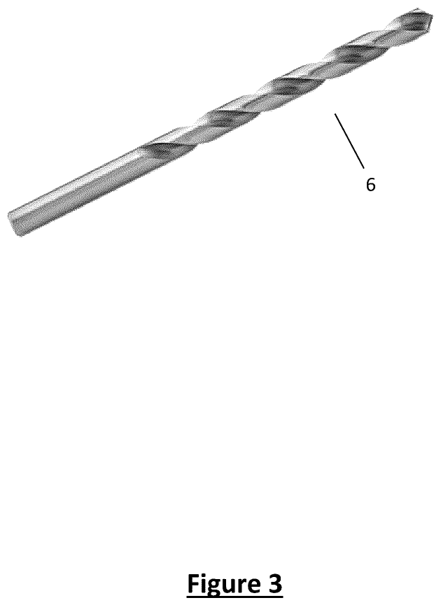

Other features of the present embodiments will be apparent from the drawings and from the Detailed Description that follows.

### DETAILED DESCRIPTION

Shock-absorbing materials are substances or structures designed to dampen or mitigate the impact force generated during collisions or sudden movements. A primary function of shock-absorbing materials is to absorb and dissipate kinetic energy, thereby reducing the transmission of harmful forces to the objects involved. They achieve this through various mechanisms, including deformation, viscoelasticity, and energy dissipation.

Many shock-absorbing materials undergo deformation upon impact. This deformation helps in spreading the force over a larger area, thus reducing the peak stress experienced at any single point. Viscoelastic materials exhibit both viscous (flow-like) and elastic (spring-like) properties. When subjected to sudden forces, such materials deform and absorb energy, behaving like a viscous fluid. Over time, they return to their original shape due to their elastic properties. This behavior allows them to dissipate energy effectively.

Some materials are engineered to dissipate energy efficiently. They may contain structures or additives that facilitate the conversion of kinetic energy into other forms, such as heat. This process reduces the intensity of the impact. Examples include materials with microstructures designed to promote frictional dissipation or those incorporating damping particles.

Combining different materials or incorporating specialized structures can enhance shock-absorbing capabilities. Composite materials often offer a balance of properties, such as strength, flexibility, and energy absorption, making them suitable for demanding applications. Examples include composite layers in protective helmets or laminated structures in vehicle crash zones.

Some common shock-absorbing materials include foams, such as polyurethane foam, ethylene-vinyl acetate foam, and viscoelastic foam; natural rubber derived from the latex of rubber trees; synthetic rubber such as neoprene, silicone, and other polymers; and gels, such as silicone gel and polymer gel; composite materials such as carbon fiber composites, fiberglass composites, elastomer/metal composites; springs such as steel springs; and liquids such as hydraulic systems.

One class of shock-absorbing materials is elastomers. An elastomer is a polymer with viscoelastic properties. Elastomers are commonly used as shock-absorbing materials due to their ability to deform under pressure and then return to their original shape once the force is removed. Elastomers include natural rubber, silicone, nylon, butyl, nitrile, and urethane.

When drilling into a medium, a shock-absorbing article may be mounted on a drill bit 6 to help protect the medium from a strike by the drill chuck. The shock-absorbing article may have a mass of shock-absorbing material 1 with a void 2 extending through the mass 1. The mass 1 may have a center-of-mass that is within the void 2, and the void 2 may be substantially a circular cylinder. The diameter of the void 2 may be substantially the same diameter as, or a greater diameter than, a diameter of the drill bit 6. The mounting may comprise sliding the drill bit 6 through the void 2. The mass 1 may be disk-shaped having the void 2 centrally located on the circular face of the disk. The mass 1 may also comprise indicia 3 that indicates the size of a compatible drill bit 6. The shock-absorbing material may be any material that absorbs and dissipates kinetic energy. In one embodiment shock-absorbing material may be an elastomer. The article may further comprise a washer 4 having a washer hole 5. The washer 4 may have a center-of-mass that is within the hole 5 and the hole 5 may be substantially a circular cylinder. The washer hole 5 may be substantially the same diameter as, or a greater diameter than, the drill bit 6. The mounting on the drill bit 6 may also comprise inserting the drill bit 6 through the hole 5 in the washer 4.

A drilling system may comprise the drill bit 6, the mass of shock-absorbing material 1, and the washer 4. The drill bit 6 may extend through the void 2 in the mass 1 and the hole 5 in the washer 4.

A method of drilling a cavity into a medium may comprise mounting a shock-absorbing article on a drill bit 6, the article comprising a mass of shock-absorbing material 1 having a void 2 through the mass 1. The mass 1 may have a center-of-mass that is within the void 2, and the void 2 may be substantially a circular cylinder. The diameter of the void 2 may be substantially the same diameter as, or a greater diameter than, the drill bit 6. The method may further comprise placing a cutting end of the drill bit 6 on the medium and rotating the drill bit 6. The mass 1 may be disk-shaped with the void 2 centrally located on the circular face of the disk. The mass 1 may have a center-of-mass that is in the void 2. The mass 1 may comprise indicia 3 that indicates the size of a compatible drill bit 6. The shock-absorbing material may be an elastomer. The article may further comprise a washer 4 having a hole 5. The washer 4 may have a center-of-mass that is within the hole 5, and the hole 5 may be substantially a circular cylinder. The diameter of the washer hole 5 may be substantially the same diameter as, or a greater diameter than, the diameter of the drill bit 6. The mounting may comprise inserting the drill bit 6 through the void 2 in the mass 1 and the hole 5 in the washer 4.

A process of making a shock-absorbing article that may be mounted on a drill bit 6 may comprise: fashioning a mass of shock-absorbing material 1 having a void 2 extending through the mass 1. The void 2 may be centrally located in the mass 1, the mass 1 may have a center-of-mass that is within the void 2, and the void 2 may be substantially a circular cylinder. The diameter of the void 2 may be substantially the same diameter as, or a greater diameter than, the drill bit 6. The fashioning may comprise: molding, stamping, extruding, casting, printing, forming, painting, machining, and cutting. The mass 1 may comprise indicia 3 that indicates the size of the drill bit 6. The mass 1 may be an elastomer. The process may further comprise selecting a washer 4 having a washer hole 5. The washer hole 5 may be centrally located in the washer 4, and may be substantially a circular cylinder. The washer hole 5 may be substantially the same diameter as, or a greater diameter than, the drill bit 6. The mounting may comprise inserting the drill bit 6 through the void 2 in the mass 1 and the hole 5 in the washer 4.

A washer 4 is a thin, flat, circular-shaped piece of metal, plastic, rubber, hard material, strong material, stiff material, or other material. A washer 4 may have a hole 5 in the center that allows it to be placed around a screw, bolt, drill bit 6, or other cylindrical object. Washers 4 are commonly used to distribute the load of a fastener over a larger surface area, thereby preventing damage to the material being fastened or providing a more secure connection. When used in shock-absorbing applications a washer 4 may distribute the shock energy over a larger surface area, thereby preventing damage to the shock-absorbing material and the target object.

A washer 4 may be flat washer 4 that has a two-dimensional shape, typically circular shape with a central hole 5, and uniform thickness. Alternatively, a washer 4 may be a lock-washer 4 that has serrations, ribs, or other variations in thickness. In addition, a washer 4 may be spring washer 4 that is designed to maintain tension or provide a cushioning effect in assemblies subject to shocks, dynamic loads, or thermal expansion. A washer 4 may be a sealing washer 4 that is designed to create a watertight or airtight seal between two surfaces. A washer 4 may be a wave washer, also known as a wave spring, that is designed with a wavy shape that provides a spring-like action when compressed axially. A washer 4 may be made of material that is harder, and/or stronger, and/or stiffer than a shock-absorbing material. In one embodiment the washer 4 may be affixed to the mass of shock-absorbing material 1 so that the mass 1 and washer 4 are mounted together on the drill bit 6. In another embodiment the washer 4 may be mounted on the drill bit 6 separately from the mass of shock-absorbing material 1.

A drill may be hand-held, portable, fixed, corded, or cordless. A drill may have a chuck that holds a drill bit 6 onto a spindle of the drill. A drill bit 6 may be a tool, especially a cutting, piercing, or grinding tool, that can be held by a drill chuck. A drill chuck may be keyed or keyless, double or single sleeve, SDS or non-SDS, hex or non-hex, three-jaw or non-three-jaw.

A mass of shock absorbing material 1 may be mounted on a drill bit 6 by inserting the drill bit 6 through a void 2 in the mass 1. A washer 4 may also be mounted on a drill bit 6 by inserting the drill bit 6 through the hole 5 in the washer 4. The void 2 or hole 5 may be any shape that allows the void 2 to accept the shaft of a drill bit 6. As used herein, a void 2 or a hole 5 is an empty space that extends completely through an object thereby increasing-by-one the topologic genus of the object. In one embodiment, the void 2 or hole 5 may be substantially a circular cylinder so that it may accept the shaft of a drill bit 6. A void 2 or hole 5 that is substantially a circular cylinder may include a void 2 or hole 5 having tabs or other variations protruding into the circular cylinder, though the drill bit 6 may still be inserted through the void 2 or hole 5. The tabs or other variations may improve the friction fit of the drill bit 6 when it is inserted into the void 2 or hole 5. A void 2 or hole 5 that is substantially a circular cylinder may thus include a void 2 or hole 5 with any variations in the cylinder that allow a drill bit 6 with a circular cylinder shaft to be inserted through the void 2 or hole 5. A void 2 or hole 5 that is substantially a circular cylinder may also include a void 2 or hole 5 that is a circular cylinder within the tolerance of the method used to manufacture it. A void 2 that is substantially a circular cylinder may be oriented so that the axis of the circular cylinder is substantially co-linear with, or substantially in the same direction as, the axis of the disk-shaped mass 1. A hole 5 that is substantially a circular cylinder may be oriented so that the axis of the circular cylinder is substantially co-linear with, or substantially in the same direction as, the axis of the washer 4.

The mass of shock absorbing material 1 may be any shape. In one embodiment, the mass 1 may be a shape that has some degree of rotational symmetry when mounted on a drill bit 6 so that it spins evenly around the drill bit 6. For example, the mass 1 may be a square shape having a substantially uniform thickness. In another example, the mass 1 may be a disk having a substantially circular face and a substantially uniform thickness. A disk has a discoidal shape. A substantially circular face may include a face that is circular within the tolerance of the method used to manufacture it. A substantially circular face may also include a face that is circular but with beveled edges, rounded edges, or without sharp edges.

The void 2 in the mass 1 may be anywhere in the mass 1 so that the void 2 extends through the mass 1. In one embodiment, the void 2 may be centrally located in the mass 1 so that the mass 1 spins evenly when mounted. For example, the mass 1 may have a center-of-mass that falls inside, or near, the void 2 so that the mass 1 spins evenly when mounted. The void 2 in the mass 1, and the hole 5 in the washer 4, may have a diameter that is substantially the diameter of the drill bit 6. The void 2 or the hole 5 may be substantially the diameter of the drill bit 6 if the drill bit 6 can be snugly inserted into the void 2 or hole 5. Here the word “substantially”, allows for the void 2 or hole 5 to be a slightly smaller diameter than the drill bit 6 so that there is a snug friction fit between the mass 1 or washer 4 and the drill bit 6. Here the word “substantially”, also allows for the void 2 or hole 5 to be a slightly larger dimeter than the drill bit 6 so that the drill bit 6 may be inserted into the mass 1 or washer 4 by hand, with minimal force. These small variations in the diameter of the void 2 or hole 5 may be necessary depending on the materials comprising the mass 1 and the washer 4.

The mass 1 may comprise indicia 3 that indicates the size of a compatible drill bit 6. The indicia 3 may comprise letter, numbers, or other symbols. The indicia 3 may comprise a scheme that indicates the size of the compatible drill bit 6 using the color of the shock-absorbing mass 1. The indicia 3 may be inherent in the mass 1 or may be applied into or onto the mass 1.

I claim:

1. A shock-absorbing article to be mounted on a drill bit, the drill bit having a first diameter, the article comprising:
a mass of shock-absorbing material; and
a void extending through the mass, wherein
the mounting comprises inserting the drill bit through the void.

2. The article of claim 1, wherein:
the mass is a disk having a substantially circular face;
the mass has a center-of-mass that is within the void;
the void is substantially a circular cylinder having a second diameter; and
the second diameter is at least one of: substantially the first diameter, and greater than the first diameter.

3. The article of claim 1, wherein the mass further comprises indicia that indicates a size of the drill bit.

4. The article of claim 1, wherein the shock-absorbing material is an elastomer.

5. The article of claim 1, further comprising a washer having a hole, wherein:
the hole is substantially a circular cylinder;
the washer has a center-of-mass that is within the hole;
the mounting further comprises inserting the drill bit through the hole; and
the hole has a third diameter that is at least one of:
substantially the first diameter and greater than the first diameter.

6. A drilling system comprising:
a drill bit having a first diameter; and
a mass of shock-absorbing material having a void extending through the mass, wherein
the drill bit extends through the void.

7. The system of claim 6, wherein:
the mass is a disk having a circular face;
the mass has a center-of-mass that is within the void;
the void is substantially a circular cylinder having a second diameter; and
the second diameter is at least one of: substantially the first diameter, and greater than the first diameter.

8. The system of claim 6, wherein the mass further comprises indicia that indicates a size of the drill bit.

9. The system of claim 6, wherein the shock-absorbing material is an elastomer.

10. The system of claim 6, further comprising a washer having a hole, wherein:
the hole is substantially a circular cylinder;
the washer has a center-of-mass that is within the hole;
the drill bit extends through the hole; and
the hole has a third diameter that is at least one of:
substantially the first diameter and greater than the first diameter.

11. A method of drilling a cavity into a medium, the method comprising:
mounting an article on a drill bit, the article comprising a mass of shock-absorbing material having a void extending through the mass;
placing a cutting end of the drill bit on the medium; and
rotating the drill bit, wherein
the drill bit has a first diameter, and
the mounting comprises inserting the drill bit through the void.

12. The method of claim 11, wherein:
the mass is a disk having a circular face;
the mass has a center-of-mass that is within the void;
the void is substantially a circular cylinder having a second diameter; and
the second diameter is at least one of: substantially the first diameter, and greater than the first diameter.

13. The method of claim 11, wherein the mass further comprises indicia that indicates a size of the drill bit.

14. The method of claim 11, wherein the shock-absorbing material is an elastomer.

15. The method of claim 11, wherein:
the article further comprises a washer having a hole,
the hole is substantially a circular cylinder;
the washer has a center-of-mass that is within the hole;
the mounting further comprises inserting the drill bit through the hole; and
the hole has a third diameter that is at least one of:
substantially the first diameter and greater than the first diameter.

16. A process of making a shock-absorbing article, the article to be mounted on a drill bit having a first diameter, wherein the process is comprised of:
fashioning a mass of shock-absorbing material, the mass having a void extending through the mass, wherein
the mounting comprises inserting the drill bit through the void.

17. The process of claim 16, wherein:
the fashioning comprises at least one of: molding, stamping, extruding, casting, printing, forming, painting, machining, and cutting;
the mass is a disk having a circular face;
the mass has a center-of-mass that is within the void;
the void is substantially a circular cylinder having a second diameter; and
the second diameter is at least one of: substantially the first diameter, and greater than the first diameter.

18. The process of claim 16, wherein the mass further comprises indicia that indicates a size of the drill bit.

19. The process of claim 16, wherein the shock-absorbing material is an elastomer.

20. The process of claim 16, further comprising:
selecting a washer having a hole, wherein
the hole is substantially a circular cylinder;
the washer has a center-of-mass that is within the hole;
the mounting further comprises inserting the drill bit through the hole; and
the hole has a third diameter that is at least one of:
substantially the first diameter and greater than the first diameter.
